(19) United States
(12) Patent Application Publication
(10) Pub. No.: US 2007/0220677 A1
(43) Pub. Date: Sep. 27, 2007

(54) Motorized adjustable support apparatus for the upholstery of furniture for lying or sitting, in particular a bed mattress

(76) Inventor: Eckhart Dewert, Zurich (CH)

Correspondence Address: SHLESINGER, ARKWRIGHT & GARVEY LLP;Suite 600, 1420 King Street, Alexandria, VA, 22314, US

(21) Appl. No.: 11/293,498

(22) Filed: Dec. 5, 2005

Related U.S. Application Data
(63) Continuation of application No. PCT/EP04/05403, filed on May 19, 2004.

(30) Foreign Application Priority Data
Jun. 5, 2003 (DE) 103 25 796.9

(51) Int. Cl. A61G 7/015

(52) U.S. Cl. 5/618; 5/616

(57) ABSTRACT

Motor-driven support apparatus for the upholstery of a piece of furniture used to sit on or lie down on, especially for a mattress for a bed. Apparatus includes a first support element having first and second longitudinal rails, and a second supporting element displaceable by a drive. The second support element is pivotable relative to the first support element. The first longitudinal rail is hollow profiled to receive parts of the drive. A drive motor is outside the first longitudinal rail, with an end opposite an output shaft of the drive motor. A recess is formed in a wall of the first rail faces the second rail. The output shaft of the drive motor, or a first transmission element, protrudes into the first rail, through the recess, and engages a second transmission element inside the first rail.

### CROSS-REFERENCE TO RELATED APPLICATIONS

This application is a continuation of application no. PCT/EP2004/005403, filed May 19, 2004, which claims the priority of German application no. 103 25 796.9, filed Jun. 5, 2003, and each of which is incorporated herein by reference.

This application relates to applicant's concurrently filed application no. [applicant's ref. 7465], entitled “Modular System for Assembling a Motorized Adjustable Support Apparatus for the Upholstery of Furniture for Sitting and/or Lying”.

### FIELD OF THE INVENTION

The invention relates to a motorized adjustable support apparatus of the type for upholstery on furniture for lying or sitting, in particular a bed mattress. More particularly, the invention relates to a motorized adjustable support apparatus for the upholstery of a piece of furniture that includes a first support element having first and second longitudinal rails, a second support element displaceable by a drive, and the second support element being pivotable relative to the first support element. Even more particularly, the first longitudinal rail may be hollow to receive parts of the drive.

### BACKGROUND OF THE INVENTION

Support apparatuses of this type are commonly known, for example, in the form of slatted frames and serve, for example, as level support surfaces for bed mattresses.

From DE 199 62 541 C2 a motorized adjustable support apparatus of the type mentioned is known, which includes a first support element, which includes longitudinal rails parallel to one another and is realized as a fixed central support element in the support apparatus, as described in the publication. That known support apparatus also includes additional support elements, which through drive means can be adjusted relative to the first support element. In the support apparatus described in the publication a first longitudinal rail of the first support element is realized as a hollow section to contain parts of the drive element, wherein the entire drive element including the drive motor is housed in the hollow first longitudinal rail. The drive motor thus does not project above the first longitudinal rail, thus giving the known support apparatus an exceptionally low height. Furthermore, the support apparatus described in the publication includes a very pleasing appearance, since it is not externally distinguishable from a conventional support apparatus, that is, one that is not motorized and adjustable.

From WO 96/29970 a motorized adjustable support apparatus for a bed mattress is known, which features arranged tandemly in the support apparatus a plurality of support elements, which through drive element can be pivoted relative to the first support element. The support elements are mounted on an outer frame, the profile height of which is significantly greater than the profile height of the support elements. In the support apparatus known from the publication, parts of the outer frame are realized as hollow section, wherein parts of the drive element for adjusting the support elements relative to one another are housed in the hollow section. The drive motor is situated on an inside of a part of the outer frame.

DE 695 07 158 T2 and EP 0 788 325 B1 each describe a motorized adjustable support apparatus for a bed mattress, which features a first support with a longitudinal rail and at least a second support element, which through drive means can be pivoted relative to the first support element. In the known support apparatus the drive motor is disposed outside the surface area of the support apparatus and is secured on a frame-like extension of the first support element.

### OBJECTS AND SUMMARY OF THE INVENTION

An object of the invention is to overcome the drawbacks of the prior art devices.

An object of the invention is to provide a motorized adjustable support apparatus of the type for upholstery on furniture for lying or sitting, in particular a bed mattress.

A further object of the invention is to provide a motorized adjustable support apparatus for the upholstery of a piece of furniture that includes a first support element having first and second longitudinal rails, a second support element displaceable by a drive, and the second support element being pivotable relative to the first support element.

A further object of the invention is to provide a first longitudinal rail which may be hollow to receive parts of the drive for this type of support apparatus.

Another object of the invention is to provide a motorized adjustable support apparatus of the type for upholstery on furniture that has a low structural height and can be manufactured in a simple and economical manner.

These and other objects have been achieved through the features of the invention set forth below.

In sum, the invention includes a motorized adjustable support apparatus for the upholstery of a piece of furniture that houses as much of the drive element, in particular a gear assembly of the drive element, as possible in a hollow first longitudinal rail of a first support element, while locating the drive motor outside the first longitudinal rail. With the drive motor located outside the first longitudinal rail and only, for example, a first gear element rotatably connected with the output shaft of the drive motor extending into the interior of the first longitudinal rail, greater freedom in gear arrangement is achieved than is found in embodiments in which all components of the drive element are disposed in the hollow longitudinal rail. In particular, the invention facilitates an especially simple and therefore economical gear arrangement, thus allowing the inventive support apparatus to be manufactured in an especially simple and therefore economical manner.

With the drive motor disposed, for example, on a lateral wall of the first longitudinal rail, which faces the other longitudinal rail and in which the recess is formed, the drive motor is at least partly concealed when the first longitudinal rail is viewed from the side and is therefore not visible in the background.

With the drive motor not disposed on an outer frame of the support apparatus, yet instead directly present on one of the support elements, an especially compact and space-saving construction is achieved.

Within the scope of the invention a support is understood as a component bearing suspension elements, for example flexible slats, for supporting upholstery and, when the upholstery is supported, absorbs the resulting bearing pressures. The support elements can be realized, for example, as longitudinal rails of the support apparatus, which rails are connected to one another via transverse rails and feature suspension elements, for example, flexible slats, on their upper surfaces. On the other hand an outer frame of a slatted frame, which is present only for lying the slatted frame in a bedstead, yet which bears no suspension elements, does not constitute a support within the scope of the invention.

According to the invention it is possible in principle that the end of the drive motor bearing the output shaft can project partly through the recess and into the interior of the first longitudinal rail. It is advantageous, however, if the drive motor is disposed substantially completely outside the first longitudinal rail. In this embodiment only the output shaft of the drive motor or the first gear element in a driven connection with the output shaft can project into the interior of the longitudinal rail.

According to the invention an optional transverse rail of the first support can be realized as a hollow section and house portions of the drive element, whereby the recess is then formed in the optional transverse rail and the drive motor is disposed on the transverse rail.

According to the invention a suitable gear arrangement can be selected according to preference, and the gear assembly in the simplest case includes only two gear elements; namely, for example, the first gear element extending through the recess and into the interior of the first longitudinal rail, and the second gear element present in the interior of the longitudinal rail. It is also possible, however, to have additional gear elements in the portion of the gear assembly disposed in the interior of the first longitudinal rail and/or in a portion of the gear assembly outside the longitudinal rail.

To facilitate an especially simple and therefore economical, while at the same time robust construction, an exceptionally advantageous embodiment of the invention provides that the first gear element is realized as a worm of a worm gear assembly, the worm wheel of which is disposed in the interior of the first longitudinal rail and constitutes the second gear element.

Worm gear assemblies of this type are available as simple and economical, as well as robust standard assemblies, and facilitate a high level of transmission even at a single gear setting. According to the invention, multiple worm gear assemblies can be coupled tandemly if necessary. As a kinematic reversal of this embodiment, the first drive element can also be realized as a worm wheel of a worm gear assembly, the worm gear of which is housed in the first longitudinal rail and constitutes the second gear element.

In the embodiment set forth above a rotational drive relationship between the worm gear and the gear elements forming the output shaft can in principle be provided between the worm gear and the output shaft of the drive motor. To facilitate an especially simple and thereby economical construction, it is advantageous, however, if the worm gear is connected nonrotatably to the output shaft of the drive motor, in particular, formed onto or integral with the output shaft of the drive motor.

To achieve an especially low construction profile of the inventive support apparatus, an especially advantageous improvement of the invention provides that the drive motor is located almost completely within the profile height of the first longitudinal rail in side view, in such a manner that the drive motor projects only insignificantly or not at all above the first longitudinal rail.

It is advantageous if the supports bear suspension elements, in particular flexible elements, such as slats, on which the upholstery of the furniture for sitting and/or lying rests when the support apparatus is used. The shape, size and number of suspension elements can be freely selected according to specific requirements.

The transmission of the drive torque of the drive motor to a support to be adjusted can be realized in a suitable manner according to preference. In an advantageous embodiment, the drive motor is in a driven connection with a linearly moving drive element, which is disposed in the interior of the first longitudinal rail and is in an actuating connection with a support element to be adjusted. In this embodiment, the rotational movement of the output shaft of the drive motor is transformed into a linear movement of the linearly moving drive element. In this embodiment a pivoting of a shaft connected nonrotatably to a support element to be adjusted is achieved in an especially simple manner.

An improvement of the embodiment mentioned above provides that the linearly moving drive element is a spindle nut, which is mounted resistant to torsion and axially movable on a threaded spindle in a driven connection with the drive motor. In this embodiment, the rotational motion of the output shaft of the drive motor is transformed into linear motion by a spindle drive. Spindle drives of this type are available as simple and economical standard building components. They are suitable for transmitting heavy forces and are especially robust.

In a kinematic reversal of the embodiment described above the linearly moving drive element can also be a threaded spindle nonrotatably mounted and axially movable and to which a fixed spindle nut is connected, which is rotatably connected with the drive motor.

In the two embodiments named above, the spindle drive is advantageously housed in the interior of the first longitudinal rail.

Another improvement of the invention provides that the rotational axis of the output shaft of the drive motor of the first gear element forms with the longitudinal axis of the first longitudinal rail, and with a linear motion axis of the linear motion drive element as well, a sharp angle, in particular an angle of approximately 90°. If the angle between the rotational axis of the first gear element and the longitudinal axis of the first longitudinal rail is approximately 90°, an especially simple and therefore economical construction is achieved, as the; gear assembly can be realized as a single worm gear assembly, the rotational axis of the worm gear and the rotational axis of the worm wheel being nearly perpendicular to one another.

To achieve a compact and low construction, it is advantageous if the profile height of the first longitudinal rail is less than 100 mm, preferably less than 85 mm.

In principle the first support element can be a moving support element. For example, it can pivot relative to another support element. An embodiment of the invention, however, provides that the first support element is a fixed support element. In this embodiment, the drive motor is disposed on a fixed support element, so that it is fixed into position as well. In this embodiment the construction is especially simple and therefore economical.

Another improvement or embodiment of the invention provides that the recess is formed in the first longitudinal rail at a region or site removed from the ends of the first longitudinal rail.

To make the drive motor even less visible and thereby further improve the appearance of the inventive support apparatus, an improvement provides that the drive motor is preferably contained in a box-like housing. The housing can fully or almost fully enclose the drive motor and thereby conceal it.

According to the particular requirements, the housing can be detachably connected to the longitudinal rail or can constitute a single piece with the first longitudinal rail, as is provided in improvements of the invention.

It is advantageous if the support apparatus is realized as a slatted frame, as is provided in an improvement of the invention.

The invention is explained in further detail below in conjunction with the attached drawings, in which embodiments of the inventive support apparatus are illustrated. All features described or illustrated in the drawing thereby constitute on their own or in any given combination the objects of the invention, independent of their summary in the patent claims or the retraction thereof as well as independent of their formulation or illustration in the description or drawing, respectively.

### BRIEF DESCRIPTION OF THE DRAWINGS

FIG. 1 is a perspective view from above of a first embodiment of an inventive support apparatus in the form of a slatted frame;

FIG. 2 is a perspective view from below of the support apparatus as shown in FIG. 1;

FIG. 3 is a side view of a detail of the support apparatus as shown in FIG. 1, wherein a half of a first longitudinal rail realized as a hollow section is omitted;

FIG. 4 is a view from above of the longitudinal rail as shown in FIG. 3;

FIG. 5 is the longitudinal rail as shown in FIG. 4, wherein the second half of the longitudinal rail is illustrated;

FIG. 6 is a section along a line VI-VI in FIG. 5;

FIG. 7 is a second embodiment of an inventive support apparatus in the same view used in FIG. 5; and

FIG. 8 is a section along line VIII-VIII in FIG. 7.

### DETAILED DESCRIPTION OF THE INVENTION

In the drawing identical and corresponding components are labeled with the same number.

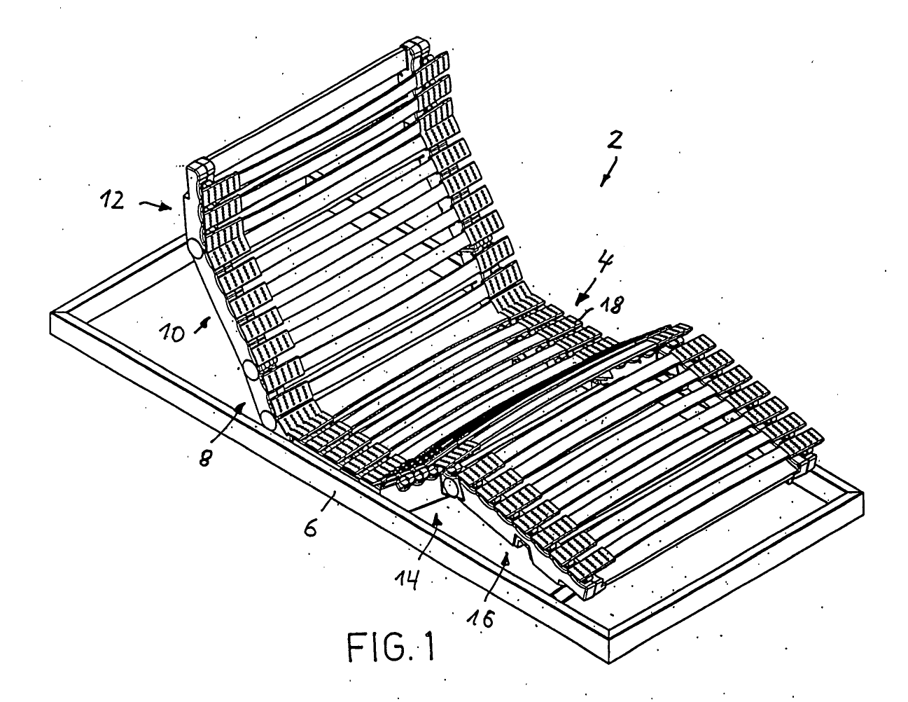

FIG. 1 illustrates a first embodiment of an inventive motorized adjustable support apparatus 2 for the upholstery of a chair or bed, which in this embodiment serves to support a bed mattress. The support apparatus 2 includes a plurality of support elements arranged tandemly lengthwise of the support apparatus 2.

In this embodiment the support apparatus 2 includes in particular a first support element 4, which in this embodiment constitutes a fixed center support element of the support apparatus 2 and is connected to an outer frame 6 of the support apparatus 2.

Connected hingedly and pivotally about a horizontal pivot axle to a side of the center support element 4 is a lumbar support 8, the side of which facing away from the center support element 4 is connected hingedly and pivotally about a horizontal pivot axle to an upper body support 10, the side of which facing away from the lumbar support 8 is connected hingedly and pivotally about a horizontal pivot axle to a head support 12.

Connected hingedly and pivotally about a horizontal axle to the side of the center support element 4 facing away from the lumbar support 8 is a leg support 14, the side of which facing away from the center support element 4 is connected hingedly and pivotally about a horizontal pivot axis to a calf support 16.

To adjust the supports 8, 10, 12, 14, 16 relative to one another as well as relative to the center support element 4 additional electromechanical drive element, which are described in further detail below, are provided. Power supply and control element for power supply and controlling the drive element are not shown in the illustration.

On their upper surfaces, the supports 4, 8, 10,12,14,16 bear suspension elements, which in this embodiment are realized as flexible slats, of which only one slat in the illustration is labeled with the number 18. In the scope of the invention, a support is understood as any part of the support apparatus that directly bears slats 18 or other suspension elements for supporting the upholstery. The outer frame 6 therefore does not constitute a support in the scope of the invention.

The supports 4,8,10,12,14,16 are shown in FIG. 1 in a first final adjustment setting of the adjustment movement, which forms a sitting position of the support apparatus 2. In another final adjustment setting of the adjustment movement not shown in the illustration the supports 4,8,10,12,14,16 form a virtually level support surface for the upholstery not shown in the illustration.

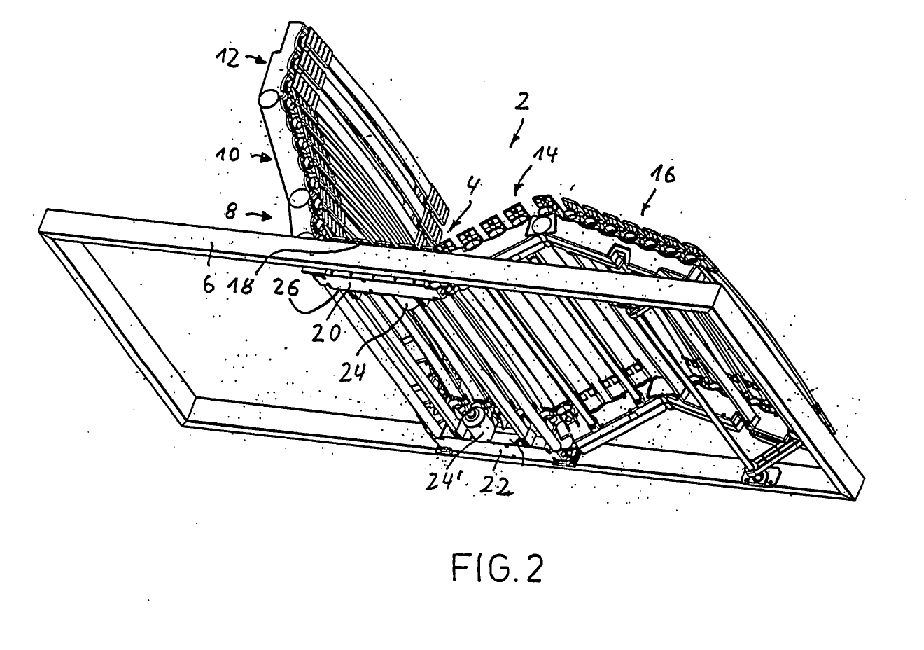

FIG. 2 is a perspective view from below of the support apparatus illustrated in FIG. 2. The center support element 4 includes a first longitudinal rail 20 running lengthwise of the support apparatus 2 and a second longitudinal rail 22 running lengthwise of the support apparatus 2. In this embodiment, the longitudinal rails 20, 22 are realized as hollow sections to house portions of the drive element and run virtually parallel to one another.

According to the invention a drive motor 24 is present outside the first longitudinal rail 20 and is disposed on and secured to a side wall 26 of the first longitudinal rail 20 opposite the second longitudinal rail 22. Not shown in FIG. 2 and therefore explained in further detail here is the fact that in the side wall 26 a recess is formed, through which in this embodiment a first gear element in a rotationally driven connection with the output shaft of the drive motor 24 projects into the first longitudinal rail 20 and engages a second gear element housed in the interior of the first longitudinal rail 20.

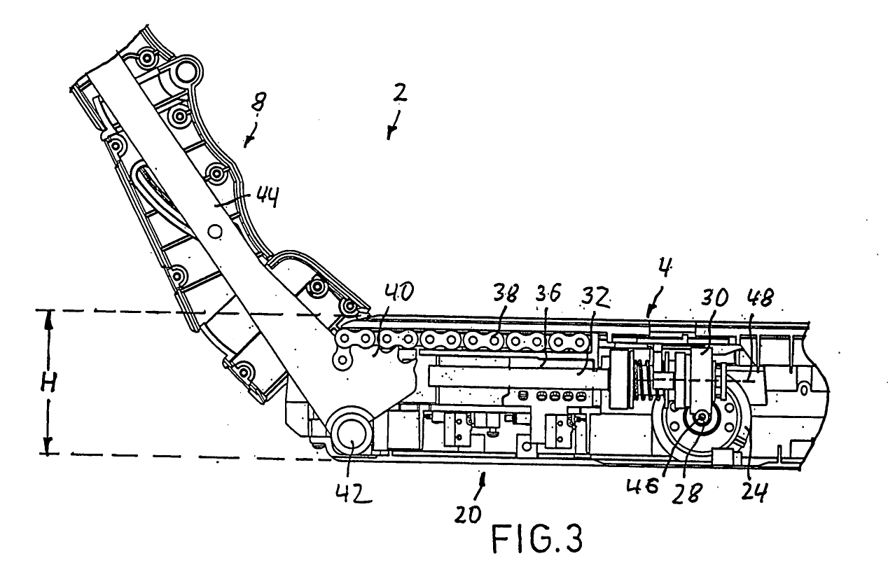

FIG. 3 is a side view of the first longitudinal rail 20, wherein, for reasons of clarity, half of the first longitudinal rail 20 is omitted. As is visible in FIG. 3, the first longitudinal rail 20 is realized as a hollow section, wherein in this embodiment all components of the drive element except for the drive motor 24 are contained in the hollow interior of the first longitudinal rail 20. In particular, the drive element in this embodiment features a worm gear drive, the worm gear 28 of which is formed with or provided on the output shaft of the drive motor 24, and projects into the interior of the first longitudinal rail 20 and engages a nonrotatably mounted worm wheel 30. The worm wheel 30 is nonrotatably connected to a threaded spindle 32 mounted rotatably in the interior of the first longitudinal rail 20, on which a spindle nut 36 movable in axial relation to the threaded spindle 32 in the direction of a double-arrow 34 is mounted resistant to torsion and forms a linearly movable drive element of the drive element. Connected with high tensile strength to the spindle nut 36 is an end of a chain 38, the other end of which engages a chain segment 40 and is secured thereto. The chain segment 40 is connected nonrotatably to a shaft 42 mounted rotatably on the first longitudinal rail 20 as well as the second longitudinal rail 22 and connected nonrotatably to an adjustment lever 44, which serves to pivot the lumbar support 8, the upper body support 10 and the head support 12.

To pivot the lumbar support 8, the upper body support 10 and the head support 12 relative to the center support element 4, the drive motor 24 drives the threaded spindle 32 in such a manner that the spindle nut 36 screws to the right in FIG. 3. Owing to the secure connection, under tension, between the spindle nut 36 and the chain segment 40 connection via the chain 38, the chain segment 40 thus pivots clockwise in FIG. 3, whereby the shaft 42 and the adjustment lever 44 also pivot clockwise in FIG. 3 and thus move lumbar support 8, upper body support 10 and head support 12 from its starting position, in which these supports span a substantially level surface, into the final position of the adjustment movement illustrated in FIG. 1. Since the transmission of the pivoting motion from the pivot lever 44 to the supports 8, 10, 12 occurs in a way familiar to one knowledgeable in the art, the associated components are not described in further detail here.

In the embodiment illustrated in FIG. 1 the second longitudinal rail 22 houses a drive element, to which a drive motor is connected and which facilitates the adjustment of leg support 14 and calf support 16 in a manner not further explained here.

The driving force of the drive motor 24 is transmitted from the side of the first longitudinal rail 20 through a transmission mechanism not illustrated in the drawing to the side of the second longitudinal rail 22, so that the drive force of the drive motor 24 is conducted on a longitudinal center plane of the support apparatus 2 substantially symmetrically to lumbar support 8, upper body support 10 and head support 12. In a corresponding manner, the drive force of the driving motor 24 is transmitted from the second support 22 to the first support 20 via a transmission mechanism not illustrated in the drawing, so that the drive force of the drive motor 24 is conducted substantially symmetrically to the leg support 14 and the calf support 16 on a longitudinal center plane of the support apparatus 2.

In a modification of this embodiment it is also possible to provide two drive motors for adjusting the supports 8, 10, 12, of which one is disposed on the first longitudinal rail 20 and the other is disposed on the second longitudinal rail 22, these drive motors being synchronously controlled. In a corresponding manner it is also possible to provide two synchronously controlled drive motors for adjusting the leg support 14 and the calf support 16, one being disposed on the first longitudinal rail 20 and the other being disposed on the second longitudinal rail 22.

As FIG. 3 illustrates, the drive motor 24 is located within a profile height of the first longitudinal rail 20, in such a manner, that the drive motor 24 does not vertically project above the first longitudinal rail 20.

The support apparatus 2 thus has an especially low height.

As FIG. 3 also illustrates that a rotation axis 46 of the worm gear 28 extends perpendicularly out of the drawing plane and forms, with a dotted line 48 pictured in FIG. 3 representing the rotational axis 48 of the worm wheel 30, an angle of approximately 90°. The gear assembly formed by the worm gear drive 28, 30 thus has an especially simple and compact construction.

Because the center support element 4 is a fixed support element, which is not moved when the other supports 8, 10, 12, 14, 16 are adjusted, the drive motor 24 always remains fixed in its position. The construction is thus further simplified.

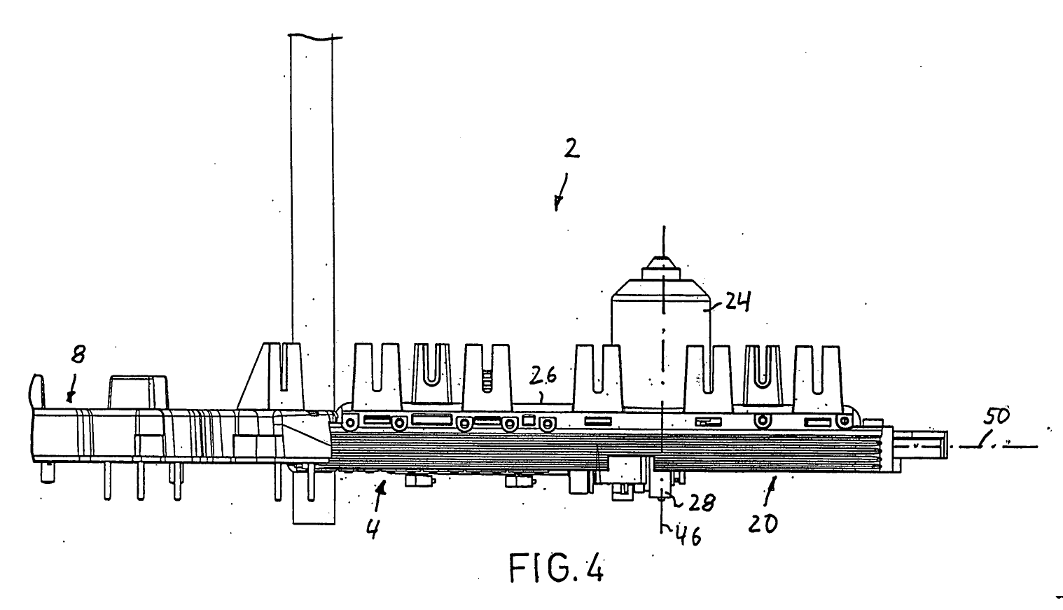

FIG. 4 shows a view from above of the first longitudinal rail 20, wherein a portion of the first longitudinal rail 20 is omitted for clarity. From the illustration it is visible that the drive motor 24 is disposed on a side wall 26 of the first longitudinal rail 20 opposite the second longitudinal rail 22 not pictured in FIG. 4, the attachment of which can be provided according to preference. In particular, the drive motor 24 can be detachably fastened to the first longitudinal rail 20. In particular, it is possible to arrange the drive motor 24 at an angular position, which engages the interior of the first longitudinal rail 20 at an angle and is in particular fastened integrally or formfitting in the interior of the longitudinal rail 20 by a suitable element according to preference.

As FIG. 4 also illustrates, the rotational axis, represented by dotted line 46 in FIG. 4, of the worm gear 28 formed on the output shaft of the drive motor 24 defines with the longitudinal axis, represented by a dotted line 50 in FIG. 4, of the first longitudinal rail 20, which in this embodiment overlaps the linear adjustment axis of spindle nut 34, an angle of approximately 90°.

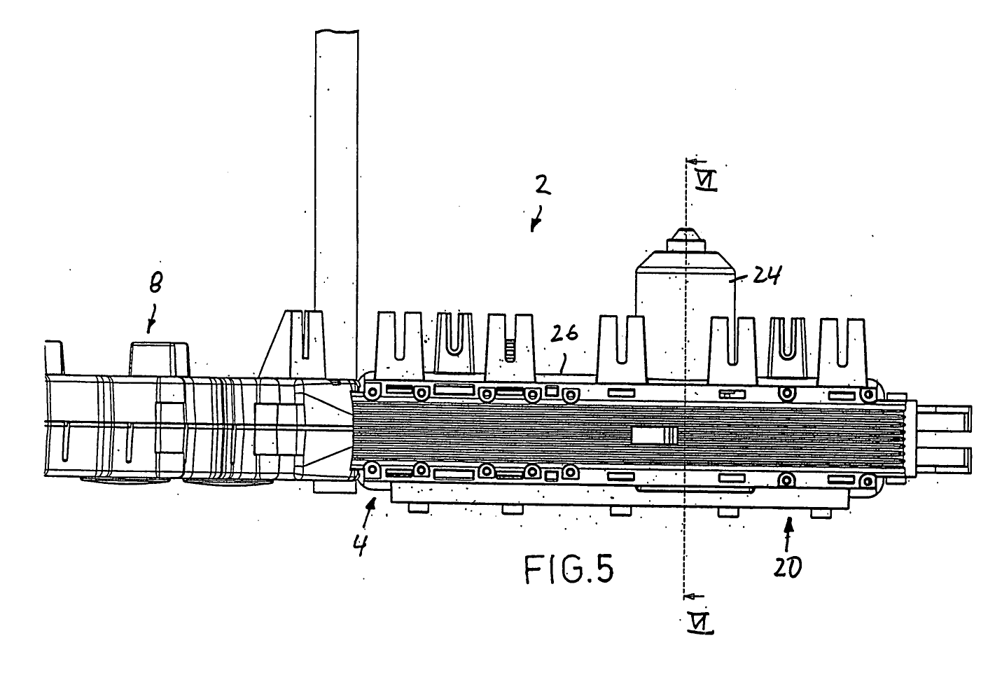

FIG. 5 is a view from above in accordance with FIG. 4, wherein a part of the longitudinal rail 20 omitted in FIG. 4 is illustrated.

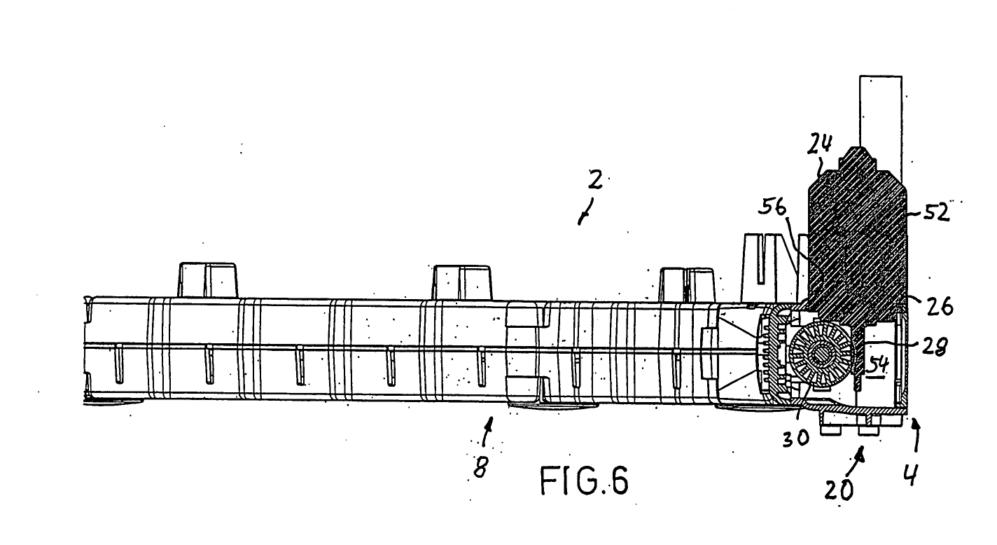

As FIG. 6 illustrates, which shows a section along line VI-VI in FIG. 5, a housing 52 of the drive motor 24 is disposed substantially completely outside a hollow interior 54 of the first longitudinal rail 20. The output shaft of the drive motor 24 and the worm gear 28 provided, such as by being formed on the output shaft, project through a recess labeled 56 in FIG. 6 in the lateral wall 26 of the first longitudinal rail 20 and into the interior of the first longitudinal rail 20 and engages the worm wheel 30 housed in the interior of the first longitudinal rail 20.

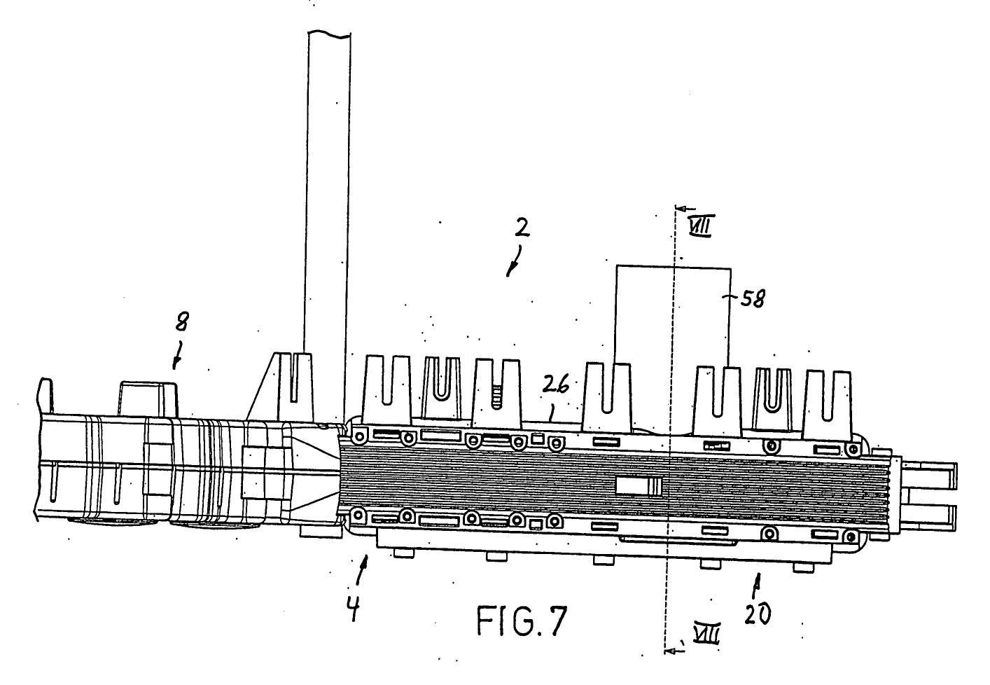

In FIG. 7 another embodiment of an inventive support apparatus is illustrated, which differs from the embodiment shown in FIG. 1 in that the drive motor 24 is disposed in a box-like housing 58, which in this embodiment is detachably connected to the first longitudinal rail 20.

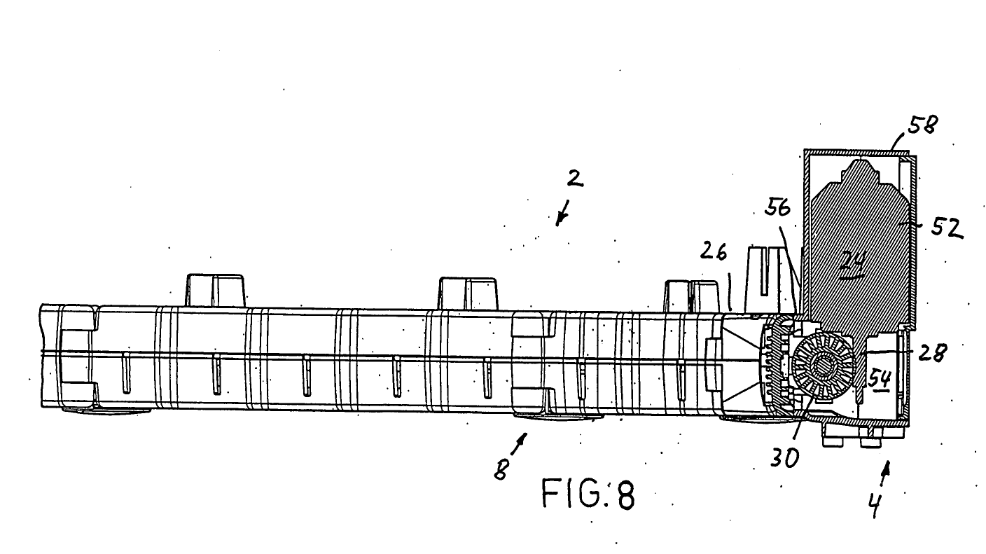

FIG. 8 shows a section along a line VIII-VIII in FIG. 7.

The inventive support apparatus includes a compact and space-saving construction, because the drive motor 24 is, first, located within the profile height of the first longitudinal rail 20 and thereby does not project above the first longitudinal rail 20 and, secondly, is disposed between the opposing side walls of the first longitudinal rail 20 and the second longitudinal rail 22. Furthermore, the inventive device 2 includes an especially simple construction and can therefore be manufactured in an especially economical manner, in particular owing to the use of a simple worm gear assembly to transmit the drive torque of the drive motor 24 to the supports to be adjusted.

While this invention has been described as having a preferred design, it is understood that it is capable of further modifications, and uses and/or adaptations of the invention and following in general the principle of the invention and including such departures from the present disclosure as come within the known or customary practice in the art to which the invention pertains, and as may be applied to the central features hereinbefore set forth, and fall within the scope of the invention or limits of the claims appended hereto.

1. Motorized adjustable support apparatus for the upholstery of a piece of furniture for one of sitting and lying, comprising:
a) a first support element including first and second longitudinal rails;
b) a second support element, the second support element being adjustable relative to the first support element;
c) a drive element including a drive motor having an output shaft, the drive element configured for adjusting the second support element relative to the first support element;
d) the first longitudinal rail including a hollow section defining an interior configured for containing a part of the drive element;
e) an end of the drive motor facing away from the output shaft of the drive motor being disposed outside the first longitudinal rail; and
f) a recess being provided in a side wall of the first longitudinal rail opposite the second longitudinal rail, and the drive motor being in a driven connection through the recess with a part of the drive element that the drive motor drives present in the interior of the first longitudinal rail.

2. Support apparatus as claimed in claim 1, wherein:
a) one of:
i) the output shaft of the drive motor,
ii) an end of the drive motor bearing the output shaft of the drive motor, and
iii) a first gear element in a driven connection with the output shaft of the drive motor and in a driven connection with a second gear element present in the interior of the first longitudinal rail
iv) projects through the recess and into the interior of the first longitudinal rail.

3. Support apparatus as claimed in claim 1, wherein:
a) the drive motor is disposed substantially completely outside the first longitudinal rail.

4. Support apparatus as claimed in claim 1, wherein:
a) the first gear element is a worm of a worm gear assembly, a worm wheel of which is disposed in the interior of the first longitudinal rail, and constitutes the second gear element.

5. Support apparatus as claimed in claim 4, wherein:
a) the worm is nonrotatably connected to the output shaft of the drive motor.

6. Support apparatus as claimed in claim 1, wherein:
a) the drive motor is located substantially within a height of the first longitudinal rail in such a manner that the drive motor is located vertically below the first longitudinal rail.

7. Support apparatus as claimed in claim 1, wherein:
a) the first and second support elements bear suspension elements, on which an upholstery of furniture for one of sitting and lying is supported when the support apparatus is in use.

8. Support apparatus as claimed in claim 1, wherein:
a) the drive motor is in a driven connection with a linearly moving drive element, which linearly movable drive element is disposed in the interior of the first longitudinal rail and is actuatingly connected with the second support element to be adjusted.

9. Support apparatus as claimed in claim 8, wherein:
a) the linearly movable drive element includes a spindle nut, which is disposed nonrotably and movably along its axis on a threaded spindle, and which is rotatably connected with the drive motor.

10. Support apparatus as claimed in claim 8, wherein:
a) the linearly movable drive element includes a threaded spindle nonrotably movable along its axis and on which a fixed spindle nut is disposed, and which is rotatably connected with the drive motor.

11. Support apparatus as claimed in claim 10, wherein:
a) a first gear element is provided; and
b) an axis of rotation of the output shaft of the drive motor for the first gear element forms with a longitudinal axis of the first longitudinal rail and with a linear movement axis of the linearly movable drive element as well a sharp angle.

12. Support apparatus as claimed in claim 1, wherein:
a) a height of the first longitudinal rail is less than about 100 mm.

13. Support apparatus as claimed in claim 1, wherein:
a) the first support element is a fixed support element.

14. Support apparatus as claimed in claim 1, wherein:
a) the recess is formed in the first longitudinal rail at a region removed from ends of the first longitudinal rail.

15. Support apparatus as claimed in claim 1, wherein:
a) the drive motor is contained in a housing.

16. Support apparatus as claimed in claim 15, wherein:
a) the housing is detachably connected to the first longitudinal rail.

17. Support apparatus as claimed in claim 15, wherein:
a) the housing is provided as one piece with the first longitudinal rail.

18. Support apparatus as claimed in claim 1, wherein:
a) the support apparatus includes a slatted frame.

19. Support apparatus as claimed in claim 1, wherein:
a) the upholstery includes a mattress.

20. Support apparatus as claimed in claim 1, wherein:
a) the drive element is configured for pivotably adjusting the second support element relative to the first support element.
